(19) United States
(12) Patent Application Publication
(10) Pub. No.: US 2013/0129457 A1
(43) Pub. Date: May 23, 2013

(54) SELF-CONTAINED MATERIAL HANDLER

(71) Applicants: John Massenburg, Seattle, WA (US); Michael D. Anderson, Puyallup, WA (US); Kevin T. Jury, Seattle, WA (US)

(72) Inventors: John Massenburg, Seattle, WA (US); Michael D. Anderson, Puyallup, WA (US); Kevin T. Jury, Seattle, WA (US)

(73) Assignee: AEROGO, INC., Seattle, WA (US)

(21) Appl. No.: 13/301,629

(22) Filed: Nov. 21, 2011

(51) Int. Cl. B66F 9/075; B66F 9/065; B62B 11/00; B60P 1/02

(52) U.S. Cl. 414/495; 414/812

(57) ABSTRACT

A self-contained material handler for lifting and manually moving a load includes a deck portion configured to be positioned beneath a load and a plurality of air casters secured on a bottom surface of the deck portion. An air source is secured to the deck portion, and the air source is in selective fluid communication with the plurality of air casters. A power source is secured to the deck portion for supplying power to the air source.

### BACKGROUND

To move heavy loads manually, air caster technology has been employed in load-moving devices to lift and move loads that would otherwise be possible only with vehicles. An air caster uses a continuous flowing film of air to virtually eliminate friction against the floor or other surface to allow easy movement and positioning of heavy loads. An air caster includes an inflation element which provides a cushion of air upon which a load-moving device can be maneuvered in any direction. In fact, the flowing film of air provided by the air caster allows loads to be moved with only a fraction of the amount of force that would be required on wheels.

Numerous load-moving devices have been developed that employ air caster technology, such as transporters, lifts, load modules, or other devices. One such device is an AirShuttle™ air pallet system available from AeroGo, Inc. of Seattle, Wash. The AirShuttle™ air pallet system is a load moving device having a low profile deck design configured to be positioned beneath, for instance, a pallet to lift the pallet from a ground surface and move or reposition the pallet. The deck has internal air casters that are inflated to provide a cushion of air upon which the deck may support the pallet to allow for easy movement.

To use the AirShuttle™ air pallet system, the air casters are connected to an external air compressor through a hose. Power is supplied to the air compressor to inflate the elements in the air casters. When inflated, the AirShuttle™ air pallet system has little to no friction as it moves across the floor, carrying and moving up to 5,000 lbs/2,270 kgs.

The low profile deck design of the AirShuttle™ air pallet system provides a low insertion point to maximize lift height of the load. Moreover, the low profile design allows for quick loading and unloading, thereby reducing assembly line transport time and overall lead time.

However, the need to connect the air casters to an external air compressor through a hose is time consuming and restricts the area in which the AirShuttle™ air pallet system may be used. Typical cordless or “self-contained” compressors suitable for inflating air casters are very large, heavy and expensive and therefore not feasible for a lightweight design of a manual air pallet system. This large size and weight make the air pallet system too heavy to move loads manually and hence require an additional drive system to provide motive force to move and/or position the load.

Thus, it is desired to have an improved load moving device that has manual load moving capabilities but that is not restricted by the requirement of connection to an external air compressor or a large drive system due the weight of a typical cordless or “self-contained” compressors or components.

### SUMMARY

A self-contained material handler for lifting and manually moving a load includes a deck portion configured to be positioned beneath a load and a plurality of air casters secured on a bottom surface of the deck portion. An air source is secured to the deck portion, and the air source is in selective fluid communication with the plurality of air casters. A power source is secured to the deck portion for supplying power to the air source.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is an isometric environmental view of a self-contained material handler formed in accordance with an exemplary embodiment of the present disclosure;

FIG. 2 is a side environmental view of the self-contained material handler of FIG. 1;

FIG. 3 is a front isometric view of a self-contained material handler of FIG. 1 shown with its housing removed;

FIG. 4 is a rear isometric view of the self-contained material handler of FIG. 3; and

FIG. 5 is a bottom isometric view of the self-contained material handler of FIG. 3;

FIG. 6 is a schematic view of an air caster system formed in accordance with an exemplary embodiment of the present disclosure; and

FIG. 7 is a schematic view of a guide wheel system formed in accordance with an exemplary embodiment of the present disclosure.

### DETAILED DESCRIPTION

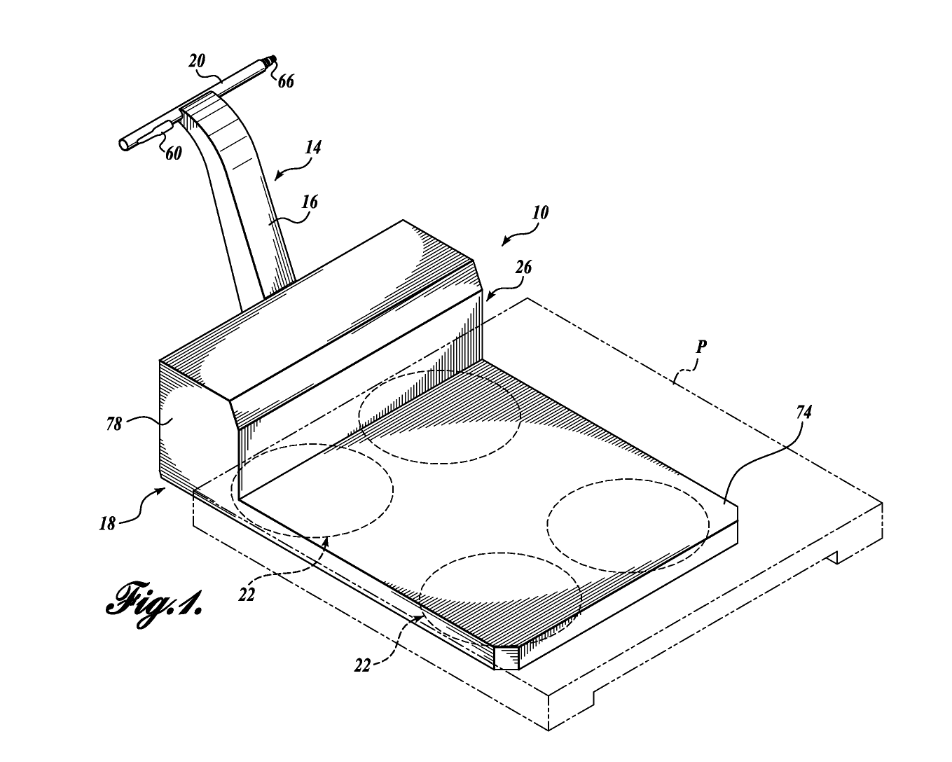

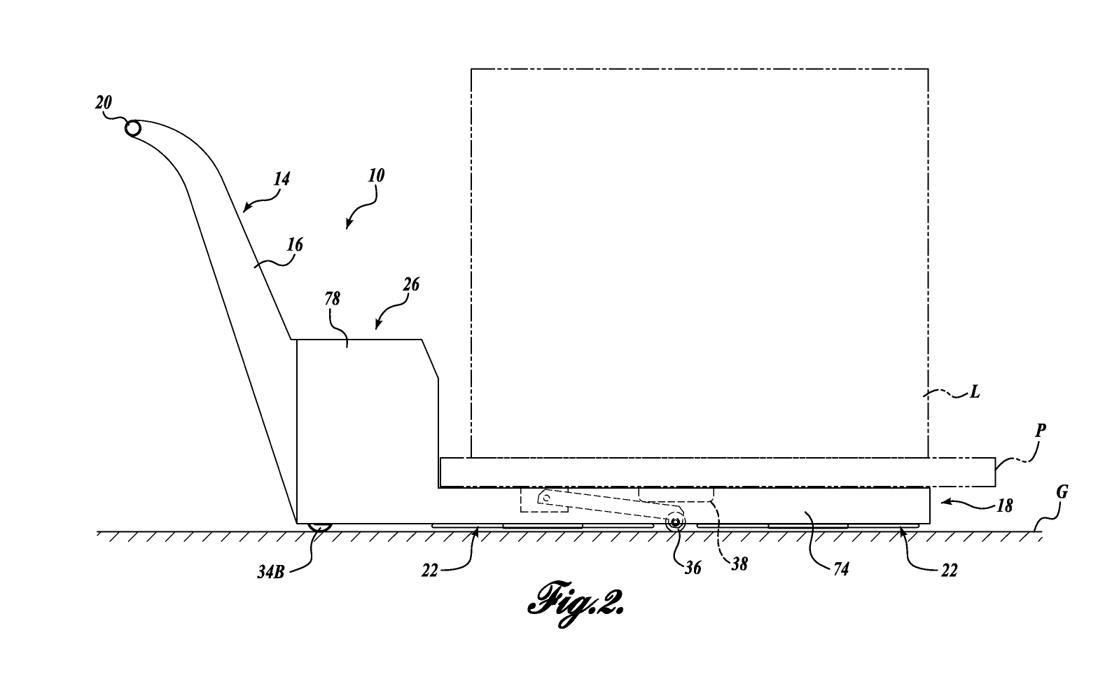

A self-contained material handler 10 formed in accordance with an exemplary embodiment of the present disclosure may best be seen by referring to FIGS. 1 and 2. The self-contained material handler 10 is a manual load moving device having an optional push handle assembly 14 extending upwardly from a deck 18. The deck 18 is a low profile design that is configured to be positioned beneath, for instance, a pallet P supporting a load L (see FIG. 2). In operation, the self-contained material handler 10 may be used to lift the pallet P from a ground surface G using the inflation of the air casters and to manually move or reposition the pallet P. The deck 18 has a plurality of air casters 22 (shown hidden) secured to its bottom surface that are inflated to provide a cushion of air upon which the deck 18 may support the pallet P to allow for easy, substantially frictionless movement across the ground surface G. The material handler 10 is self-contained in that it includes internal components for inflating the inflation elements in the air casters 22, but without the need for large and heavy drive components to supply pressurized air to the air casters 22. Therefore, the self-contained material handler 10 does not necessitate connection to an external air source for operation or require a drive system to provide the motive force due to the heavy weight.

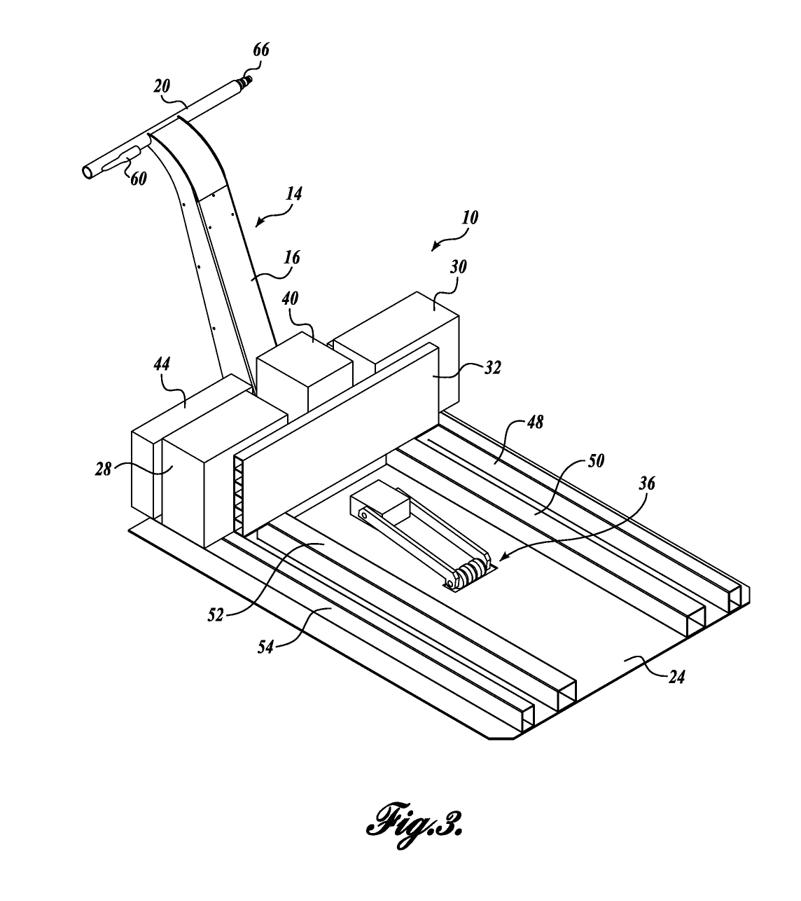

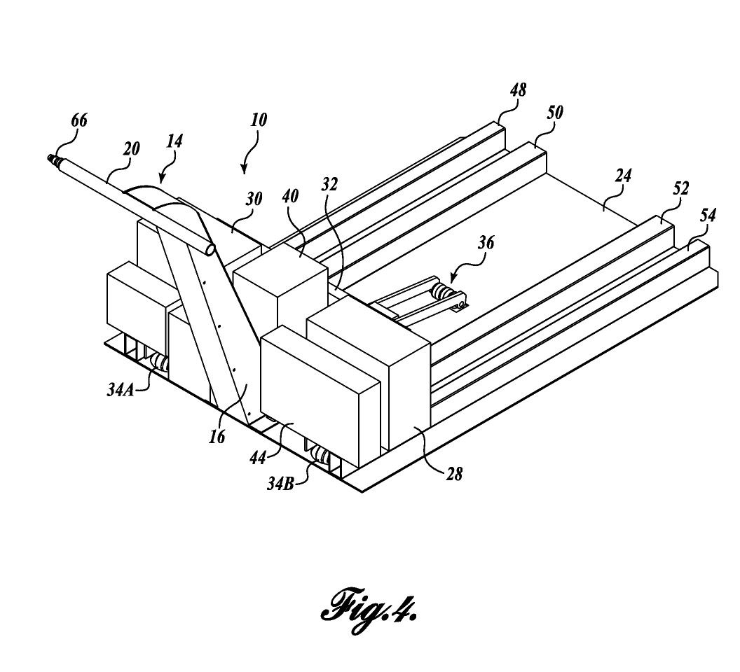

Referring additionally to FIGS. 3-5, the components of the self-contained material handler 10 will now be described in detail. As noted above, the self-contained material handler 10 is generally comprised of an optional push handle assembly 14 extending upwardly from a deck 18. The push handle assembly 14 may be any suitable design and configuration for steering and pushing the self-contained material handler 10 both when the air casters 22 are inflated and deflated.

In the depicted embodiment, the push handle assembly 14 includes an arm 16 secured to and extending upwardly from the deck 18 and a handle 20 secured transversely to the upper end of the arm 16. The arm 16 has a thickness and is hollow in construction to enclose any electrical wiring, hoses, etc., that extend between the handle 20 and the deck 18. The handle 20 may be any suitable contour and shape, such as cylindrical, to be appropriately gripped by the user when moving and steering the self-contained material handler 10.

As noted above, the push handle assembly 14 may be optional or instead removable in the event that the end user does not need a push handle assembly 14. This may occur if, for instance, the end user is securing a portion of a tooling fixture or another structure to the deck 18 to fully integrate the self-contained material handler 10 into a portion of a manufacturing or assembly process.

The deck 18 extends from the push handle assembly 14 and it is sized and shaped to fit beneath and support a desired load. For instance, as shown in FIGS. 1 and 2, the deck 18 may be low profile in size and shape to fit within the opening of a pallet P and support and balance the load L of the pallet P. In that regard, the deck 18 includes a substantially flat frame 24 that is enclosed by a housing 26. The frame 24 is positionable substantially parallel to the ground surface G when in use, thereby allowing the deck 18 to fit beneath a pallet P.

As noted above, the deck 18 is movable by inflating the air casters 22 to provide a cushion of air on which the deck 18 may glide. When the air casters 22 are not inflated, the deck 18 may be moved on a set of wheeled caster assemblies and a guide wheel assembly. In particular, a pair of rear wheeled caster assemblies 34A and 34B and a front guide wheel assembly 36 extending from the bottom surface of the frame 24 allows the self-contained material handler 10 to move when the air casters 22 are not inflated. Such movement may be desired when the deck 18 contains no load; and therefore, the substantially frictionless movement provided by the air casters 22 is not necessary. For instance, the deck 18 may be positioned beneath the pallet P by rolling the frame on the wheeled caster assemblies 34A, 34B and the guide wheel assembly 36. After the deck 18 is positioned beneath the pallet P, the air casters 22 may be inflated to lift the pallet P off the ground surface G and to move the pallet P to a different location.

The guide wheel assembly 36 may also optionally be used to direct the self-contained material handler 10 when the air casters 22 are inflated. As noted in the Background section above, air casters, when inflated, provide a cushion of air upon which a load-moving device can be maneuvered in any direction. Thus, if the ground surface G is sloped, it may be difficult for the user to prevent the self-contained material handler 10 from moving in the direction of the downward slope. If the guide wheel assembly 36 is engageable with the ground surface G when the air casters 22 are inflated, the guide wheel assembly 36 can guide the self-contained material handler 10 in a direction substantially perpendicular to the roller axis of the guide wheel assembly 36. Although the guide wheel assembly 36 may be selectively engaged with the ground surface in any suitable manner, an air bag 38 positioned above the guide wheel assembly 36 may be inflated to depress the guide wheel assembly 36 down into engagement with the ground surface G while the air casters 22 are in use.

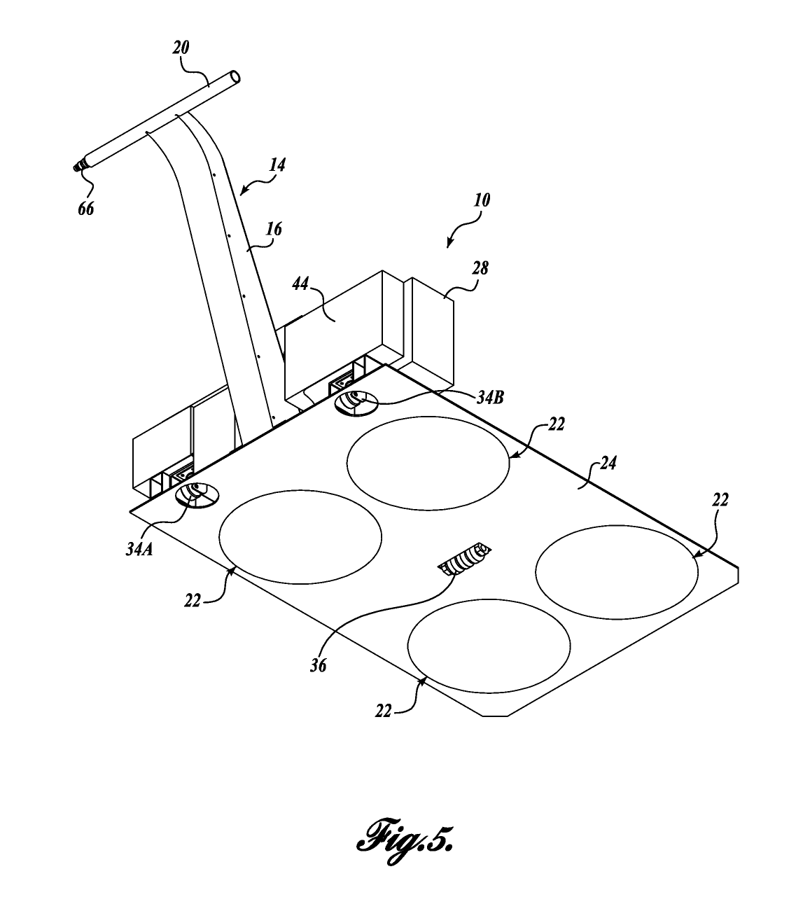

As shown specifically in FIGS. 2 and 5, the air casters 22 are secured to the bottom surface of the frame 24 to lift and move the pallet P and its load L when the air casters 22 are inflated. In the depicted embodiment, four commercially available air casters 22 available from AeroGo Inc. of Seattle, Wash. (Model Number 21N), may be used. As a non-limiting example, the air casters 22 operating on compressed air of 6 psi will collectively support and provide the ability to manually move a load of up to about 4,000 pounds.

However, it should be appreciated that fewer or more than four air casters may be used to decrease or increase the amount of load that may be supported and moved. As a specific example, eight air casters 22 could be used to support and move a load of up to about 8,000 pounds. In the alternative, the level of air pressure being supplied to the air casters could be decreased or increased to decrease or increase the amount of load that may be supported and moved. As a specific example, air casters 22 operating on compressed air of about 12 psi could support and move a load of up to about 8,000 pounds.

The internal components for inflating the air casters 22 and optionally the guide wheel assembly 36 without the need for connection to an external air source and without the need for a large internal drive system or components will now be described in detail. The internal components may be secured to the top surface of the frame 24 near the attachment of the lower end of the arm 16. The internal components may be arranged and secured to the frame 24 in any suitable manner, depending on their size and shape. Preferably, the internal components are arranged on the frame 24 in a compact manner with little to no space between each of the internal components, thereby minimizing the overall size of the self-contained material handler 10. It should be appreciated that one or more of the internal components may instead be secured to another portion of the self-contained material handler 10, such as the push handle assembly 14.

The internal components include a first lightweight air compressor 28 for supplying pressurized air to the air casters 22 for inflating the elements in the air casters 22. The first air compressor 28 provides a high volume of low pressure air (similar to an air blower) to sustain a pressure of about 6 psi. Any suitable air compressor, blower, or similar device may be used, such as the Ametek blower motor (Manufacturer Part Number 119292-00) available from Ametek, Inc., of Berwyn, Pa. The high volume of low pressure air provided by the first air compressor 28 is suitable for sustaining a pressure of about 6 psi within the air casters 22 without the need for a large and heavy secondary drive component.

A second air compressor 30 is included for supplying pressurized air to the air bag 38 when the guide wheel assembly 36 is needed to help direct the forward movement of the self-contained material handler 10 when the air casters 22 are inflated. The second air compressor 30 is suitable to provide compressed air at about 10 psi to inflate the air bag 38 for engaging the guide wheel assembly 36 with the ground surface G. The second air compressor 30 is any suitable commercially available air compressor, such as a 24V 330C-IG air compressor available from VIAIR Corporation of Irvine, Calif. (Manufacturer Part Number 33058).

The first and second compressors 28 and 30 may be powered by a battery 32 having sufficient voltage, such as 24 VDC. Any suitable commercially available battery may be used, such as Manufacturer Part Number GPL-30HT (150 amp-hour) available from Lifeline Batteries Inc. of Azusa, Calif.

In that regard, a battery charger 40 is also secured to the frame 24 and is capable of recharging the battery 32 either during operation or when plugged into an electrical outlet when the self-contained material handler 10 is not in use. Any suitable commercially available battery charger may be used, such as Manufacturer Part Number DLS-27-25 available from IOTA Engineering, L.L.C, of Tucson, Ariz. In addition, an inverter 40 is secured to the frame 24 for supplying power from the battery 32 to the air compressor 30. The inverter 40 may be any commercially available inverter, such as Manufacturer Part Number PWRINV2500W available from AIMS Power of Reno, Nev. However, it should be appreciated that in certain embodiments, the inverter 40 may be eliminated.

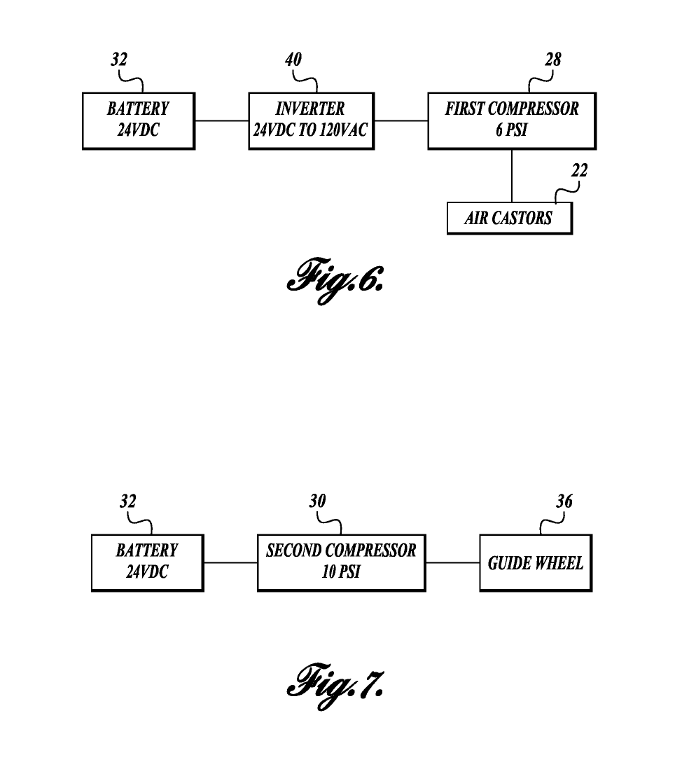

Referring to FIGS. 6 and 7, the first air compressor 28, second air compressor 30, battery 32, battery charger 40, and inverter 44 are placed into electrical communication with one another in a manner well known in the art. Referring to FIG. 6, an air caster assembly is defined by the battery 32, inverter 40, first air compressor 28, and air casters 22. The battery 32 provides power to the first air compressor 28 through the inverter 40, and the first air compressor 28 is in fluid communication with the air casters 22 through pneumatic lines (not shown) so that the first air compressor 28 can transmit pressurized air to the inflation elements within each air caster 22.

Similarly, referring to FIG. 7, a guide wheel assembly is defined by the battery 32, second air compressor 30, and guide wheel assembly 36. The battery 32 provides power to the second air compressor 30, and the second air compressor 30 is in fluid communication with the air bag 38 of the guide wheel assembly 36 through pneumatic lines (not shown) so that the second air compressor 30 can transmit pressurized air to the air bag 38. When the air bag 38 is inflated, it depresses the guide wheel assembly 36 into engagement with the ground surface G.

To house at least some of the pneumatic lines, first, second, third, and fourth elongated hollow channels 48, 50, 52, and 54, respectively, extend longitudinally along the length of the upper surface of the frame 24 between the first and second air compressor 28 and 30 and the forward end of the frame 24. The elongated hollow channels 48, 50, 52, and 54 may also be used to position the first air compressor 28, second air compressor 30, battery 32, battery charger 40, and inverter 44 a predetermined distance above the upper surface of the frame 24 to provide space for interconnecting the components. More specifically, the first air compressor 28, second air compressor 30, battery 32, battery charger 40 and inverter 44 may be mounted to the top surfaces of the channels 48, 50, 52, and 54 to define a gap beneath the components to house cables, wiring, etc.

The components of the self-contained material handler 10 may be controlled through a switch, a control panel, etc., located on the arm 16, the handle 20, or another suitable location. For example, one or more of the components may be controlled by a lever 60 located on the handle 20 of the push handle assembly 14. The lever 60, for instance, may be used to turn on the necessary components to provide power to the first and second air compressors 28 and 30 to inflate the air casters 22 and to engage the guide wheel assembly 36.

In the event that any of the components fail, the self-contained material handler 10 may include a valve 66 extending laterally from an end of the handle 20. The valve 66 is in fluid communication with the air casters 22 through pneumatic lines (not shown) that extend through the handle 20, through the arm 16, and down through the channels 48, 50, 52, and 54. The valve 66 may be placed into fluid communication with an external air hose to inflate the air casters 22 (and optionally the air bag 38 of the guide wheel assembly 36) to operate the self-contained material handler 10.

The self-contained material handler 10 may further include a power cord or a power cord connector (both not shown) for providing electrical power to one or more of the components when needed. For instance, if the battery 32 has failed, if the battery 32 needs to be re-charged, or if the self-contained material handler 10 needs to be used for a prolonged period of time, power may be supplied to the battery 32 through a power cord plugged into an external electrical power outlet. Moreover, some users may prefer to use external power at all times. In this instance, the self-contained material handler 10 may contain no battery 32, battery charger 40, or inverter 44. Thus, it should be appreciated that although the self-contained material handler 10 is shown and described as having a first air compressor 28, second air compressor 30, battery 32, battery charger 40 and inverter 44, the components may be removed or interchanged with other known components as needed to create a desired configuration.

As noted above, the components are secured compactly on the top surface of the frame 24 near the lower end of the arm 16. The components and the channels 48, 50, 52, and 54 are enclosed with the housing 26 to define a deck portion 74 and a component portion 78. The deck portion 74 is substantially planar and rectangular in cross-section such that it is sized and shaped to fit within the opening of a pallet P and support and balance the load L of the pallet P. However, it should be appreciated that the deck portion 74 may instead be any suitable shape, size, and configuration to support and move a desired load.

The component portion 78 may be defined in part by the size and arrangement of the components enclosed within the component portion 78. However, the component portion 78 may also be designed to engage some or all of the load, such as a portion of the pallet P or its load L. The component portion 78 may further be designed to house a control panel, an instruction panel, or other components of the self-contained material handler 10. Thus, the descriptions and illustrations set forth herein of the deck portion 74 and the component portion 78 should not be seen as limiting the scope of the claimed subject matter.

To use the self-contained material handler 10, the user may grasp the handle 20 and move the deck 18 toward the desired load by rolling it along the rear wheeled casters 34A/B and the front guide wheel assembly 36. The deck portion 74 is positioned beneath the desired load. For instance, if the load L is on top of a pallet P, the deck portion 74 is rolled within the opening beneath the pallet P.

With the deck portion 74 positioned beneath the pallet P, the lever 60 may be actuated to turn on the necessary components to provide power to the first air compressor 28 so that pressurized air is fluidly communicated to the air casters 22 through the first air compressor 28. If needed, the components may be placed into electrical communication with an electrical outlet through a power cord. Instead of using the internal first air compressor 28, the valve 66 may be connected to an external air hose that can provide pressurized air to the air casters 22.

When the air casters 22 are inflated, they lift the pallet P vertically off the ground surface G, thereby eliminating the need for a separate jacking operation. Moreover, with the air casters 22 inflated and the pallet P lifted, the self-contained material handler 10 can be used to manually “float” the pallet P with its load L across the ground surface, almost frictionless. As such, the self-contained material handler 10 can be used to lift and manually move heavy loads (up to about 4,000 pounds) without scratching or damaging delicate or expensive floors. Moreover, unlike casters or wheels, the air casters provide omnidirectional movement, requiring no additional force to change direction. This allows awkward or bulky loads to be maneuvered in tight spaces that would be very difficult to move with conventional methods.

In that regard, if the omnidirectional movement of the self-contained material handler 10 cannot be controlled due to, for instance, the slope of the ground surface G, the air bag 38 of the guide wheel assembly 36 may be inflated by the second air compressor 30. When inflated, the air bag 38 depresses the guide wheel assembly 36 into engagement with the ground surface G to steer the self-contained material handler 10 in a forward direction.

Furthermore, although the self-contained material handler 10 has the option to be connected to external power or air sources, the self-contained material handler 10 is configured to be used as a self-contained, cordless unit that is not restricted by cords, outlets, air sources, etc. Thus, the self-contained material handler 10 has the capability of being used in many different environments and situations.

For instance, one non-limiting example of a method of using the self-contained material handler 10 may include lifting and moving parts, components, tooling, partial assemblies, equipment, etc., in an industrial manufacturing assembly plant or factory. Many modern factories have large facilities that contain heavy equipment used for assembly line production, packaging, and distribution. The self-contained material handler 10 could be used to move equipment that needs to be moved often between assembly lines. Moreover, the self-contained material handler 10 could be used to move heavy parts or partial assemblies made with the equipment from one assembly line to another or from one section of the factory to another (i.e., from packaging to distribution). The self-contained material handler 10 could replace motorized vehicles or overhead cranes normally used in these applications.

As another non-limiting example, a method of using the self-contained material handler 10 may include moving inventory, supplies, shipments, etc., within an industrial warehouse. For instance, the self-contained material handler 10 may be used to move pallets of inventory in between storage locations and/or from storage locations into trucks, containers, and the like.

In both of the foregoing examples, the use of the self-contained material handler 10 within the factory or the warehouse is not restricted by an electrical cord or air hose. Moreover, the low profile design of the self-contained material handler 10 enables it to be maneuvered in tight or confined spaces and allows for quick loading and unloading, thereby reducing assembly line transport time and overall lead time. The inventors have found that by using a self-contained material handler 10 similar to that shown and described in the present disclosure, a manufacturing facility can realize up to 50% less cycle time and 75% increase in production.

While illustrative embodiments have been illustrated and described, it will be appreciated that various changes can be made therein without departing from the spirit and scope of the present disclosure.

The embodiments of the present disclosure in which an exclusive property or privilege is claimed are defined as follows:

1. A self-contained material handler for lifting and manually moving a load, comprising:
(a) a deck portion configured to be positioned beneath a load;
(b) a plurality of air casters secured on a bottom surface of the deck portion;
(c) an air source secured to the deck portion, the air source in selective fluid communication with the plurality of air casters; and
(d) a power source secured to the deck portion for supplying power to the air source.

2. The self-contained material handler of claim 1, further comprising a handle assembly extending from the deck portion.

3. The self-contained material handler of claim 1, wherein the air source is a first air compressor requiring no secondary drive component.

4. The self-contained material handler of claim 3, wherein the first air compressor supplies pressurized air to the air casters at about 6 psi.

5. The self-contained material handler of claim 1, wherein the power source is a battery.

6. The self-contained material handler of claim 5, wherein the battery is configured to be selectively placed into electrical communication with an external power source.

7. The self-contained material handler of claim 1, further comprising an inverter in electrical communication with the battery and the air source.

8. The self-contained material handler of claim 1, further comprising a guide wheel assembly selectively engageable with a ground surface by an inflatable air bag.

9. The self-contained material handler of claim 8, further comprising a second air compressor for supplying pressurized air to the inflatable air bag.

10. A method for lifting and manually moving parts, components, tooling, partial assemblies, and equipment, in an industrial manufacturing assembly plant or factory, the method comprising:
(a) providing a self-contained material handler, comprising:
(i) a deck portion configured to be positioned beneath a load;
(ii) a plurality of air casters secured on a bottom surface of the deck portion;
(iii) an air source secured to the deck portion, the air source in selective fluid communication with the plurality of air casters; and
(iv) a power source secured to the deck portion for supplying power to the air source;
(b) positioning the deck portion beneath one of a portion of parts, components, tooling, partial assemblies, and equipment in an industrial manufacturing assembly plant or factory;
(c) actuating the air source to inflate the plurality of air casters; and
(d) manually moving the portion of parts, components, tooling, partial assemblies, and equipment from a first area in the industrial manufacturing assembly plant or factory to a second area in the industrial manufacturing assembly plant or factory.

11. The method of claim 10, further comprising manually moving the portion of parts, components, tooling, partial assemblies, and equipment from a first assembly line to a second assembly line.

12. The method of claim 10, wherein the air source of the self-contained material handler is a first air compressor requiring no secondary drive component.

13. The method of claim 10, wherein the power source of the self-contained material handler is a battery.

14. A method for lifting and manually moving a load, the method comprising:
(a) providing a self-contained material handler, comprising:
(i) a deck portion configured to be positioned beneath a load;
(ii) a plurality of air casters secured on a bottom surface of the deck portion;
(iii) an air source secured to the deck portion, the air source in selective fluid communication with the plurality of air casters; and
(iv) a power source secured to the deck portion for supplying power to the air source;
(b) positioning the deck portion beneath one of a portion of inventory, supplies, and shipments in an industrial warehouse;
(c) actuating the air source to inflate the plurality of air casters; and
(d) manually moving the portion of inventory, supplies, and shipments from a first area in the industrial warehouse to a second area in the industrial warehouse.

15. The method of claim 14, further comprising manually moving the portion of inventory, supplies, and shipments from a first storage location to a second storage location.

16. The method of claim 14, further comprising manually moving the portion of inventory, supplies, and shipments from storage locations into trucks and containers.

17. The method of claim 14, wherein the air source of the self-contained material handler is a first air compressor requiring no secondary drive component.

18. The method of claim 14, wherein the power source of the self-contained material handler is a battery.
